(19) United States
(12) Patent Application Publication
(10) Pub. No.: US 2015/0127950 A1
(43) Pub. Date: May 7, 2015

(54) METHOD OF ENCRYPTING DATA

(71) Applicant: David Irvine, Troon (GB)

(72) Inventor: David Irvine, Troon (GB)

(21) Appl. No.: 14/394,755

(22) PCT Filed: Apr. 11, 2013
(86) PCT No.: PCT/GB2013/050936

§ 371 Date: Oct. 16, 2014

(30) Foreign Application Priority Data
Apr. 16, 2012 (GB) 1206636.1

(51) Int. Cl. H04L 9/32

(52) U.S. Cl. CPC H04L 9/3228; H04L 9/3236
USPC 713/184

(57) ABSTRACT

A method of encrypting data comprising the steps of: creating a one time pad; and encrypting the data using the one time pad to produce output data, wherein the one time pad is generated using the data.

The present invention relates to methods of encrypting and decrypting data. In particular, but not exclusively, the invention relates to improved methods which have, or come closer to having, perfect secrecy.

A perfectly secure cryptosystem is secure even when an adversary has unlimited computing power. It uses an encryption algorithm that does not depend for its effectiveness on unproven assumptions about computational hardness. The algorithm is not vulnerable to future developments, such as quantum computing.

In cryptography, there are two types of encryption: symmetric key cryptography and asymmetric key (also known as public-key) cryptography. With the former type, trivially related or identical cryptographic keys are used for both encryption of plaintext and decryption of ciphertext. With the latter, two different but mathematically related keys are used: a public key and a private key. The calculation of the private key is intended to be ‘computationally infeasible’ from the public key, even though they are related.

Conventional symmetric encryption involves complex substitution and transposition of data. At present, and despite their prevalence, it is not known whether there can be a cryptanalytic procedure which can reverse these transformations without knowing the key used during encryption. Symmetric ciphers have been susceptible to various forms of attacks, and it does appear that there is ongoing progress towards developing such a cryptanalytic procedure.

For instance, one example of a popular symmetric algorithm is AES. Until May 2009, the only successful published attacks against the full AES were side-channel attacks on some specific implementations. In December 2009 an attack on some hardware implementations was published that used differential fault analysis. In November 2010, a published paper described a practical approach to a “near real time” recovery of secret keys from AES-128 without the need for either cipher text or plaintext. The first key-recovery attacks on full AES were published in 2011.

Another significant disadvantage of symmetric encryption is the key management required to use it securely. Each distinct pair of communicating parties must, ideally, share a different key, and usually each ciphertext exchanged as well. The number of keys required therefore increases in relation to the square of the number of network members.

Asymmetric encryption relies on mathematical problems that are thought to be difficult to solve, such as integer factorization or discrete logarithms. However there is no proof that a mathematical breakthrough could not occur which would make existing systems vulnerable to attack. Known asymmetric encryption methods are also computationally costly and slower compared with most symmetric key algorithms of equivalent security.

There are therefore disadvantages with both types of cryptography, and most practical encryption systems are therefore hybrid systems. A shared secret key, or session key, is generated by one party and this much shorter session key is then encrypted by each recipient's public key. Each recipient uses the corresponding private key to decrypt the session key. Once all parties have obtained the session key they can use a much faster symmetric encryption algorithm to encrypt and decrypt messages.

It is desirable to provide an improved method of encrypting data which is, or is closer to being, perfectly secure.

The conventional encryption of data involves encrypting data as a whole. This reduces the potential set of possible inputs. For instance, if an individual's bank statement is encrypted, the output will be approximately the same size as the original bank statement. Furthermore, the security of a whole piece of data encrypted using a single algorithm depends upon that single algorithm not getting broken. One possible solution is to encrypt bits of files. However, this would require many passwords or algorithms.

Among symmetric key encryption algorithms, only the “one-time pad” has been proven to be secure, indeed perfectly secure, no matter how much computing power is available. In a one-time pad (OTP), each bit or character from the plaintext is encrypted by a modular addition with a bit or character from a secret random key of the same length as the plaintext, resulting in the ciphertext.

It has been proven that, if the key is truly random, as large as or greater than the plaintext, never reused in whole or part, and kept secret, the ciphertext will be impossible to decrypt or break without knowing the key. The method can be implemented as a software program, using data files as input (plaintext), output (ciphertext) and key data (the required random sequence). The XOR operation is often used to combine the plaintext and the key elements, since it is usually a native machine instruction and is therefore very fast.

However, practical problems have prevented one-time pads from being widely used. There must be secure generation and exchange of the key, which must be at least as long as the message. Also, importantly, sufficiently random numbers are difficult to generate using a computer. The random number generators in most programming languages are not suitable for cryptographic use. Even those generators that are suitable for normal cryptographic use involve cryptographic functions whose security is unproven.

It is desirable to provide an improved method of encrypting data which utilises the concept of the one-time pad but which overcomes one or more of the limitations of existing implementations.

According to the present invention there is provided a method of encrypting data comprising the steps of:
creating a one time pad;
encrypting the data using the one time pad to produce output data,
wherein the one time pad is generated using the data.

The method may include splitting the data into a plurality of data portions. The method may include taking a hash of each data portion.

The method may include obfuscating the data. The method may include obfuscating each data portion. The method may include obfuscating each data portion by concatenating the hashes of one or more other data portions.

The method may include encrypting the obfuscated data using the one time pad.

The one time pad may comprise key data which is generated by encrypting the data. The encryption process used to generate the key data may include one or more encryption parameters derived from the data. The one or more encryption parameters may be derived from one or more data portions. The encryption parameter may comprise an encryption key. The encryption parameter may comprise an initialisation vector.

The key data may be at least the same length as the data.

The encrypted data may be named using a hash of the encrypted data and then stored.

The method may include generating a data map for decrypting the output data. The data map may comprise the one or more encryption parameters.

The method may include generating a data atlas from a plurality of data maps. The data atlas may comprise a plurality of concatenated data maps.

The method may include removing duplicate information. The method may include at least reducing the number of multiple versions of identical data portions.

Embodiments of the present invention will now be described, by way of example only.

The present invention can provide a system of encryption that requires no user intervention or passwords. The resultant data item then has to be saved or stored somewhere as in all conventional methods. The encryption method of the invention relates to creating cipher-text (encrypted) objects that are extremely strong and closer to perfect in terms of reversibility, as opposed to known encryption ciphers. The method is based on symmetric encryption, and enhances this approach to produce highly secure data.

Within this specification, the following notation will be used:

H=Hash function such as SHA, MD5 or the like;

Symm=Symmetrical encryption such as AES, 3DES or the like;

PBKDF2=Password-Based Key Derivation Function or similar;

f_{c}=file content;

fₘ=file metadata;

fh=H(f_{c}) or fh=H(H(C₁)+H(C₂)+ . . . H(Cₙ₋₁), where Cₙ is a data chunk;

The embodiment below will use AES as an example of a symmetric encryption algorithm and therefore will use a key and initialisation vector and plain-text input data.

Difficult to guess and uncompress-able output equates to random results based on random input data and random, unrelated algorithm inputs (plain text, key and iv in the case of modern symmetric ciphers).

The ideal cryptographic hash function has four main or significant properties. It is easy (but not necessarily quick) to compute the hash value for any given message; it is infeasible to generate a message that has a given hash; it is infeasible to modify a message without changing the hash; and it is infeasible to find two different messages with the same hash.

A cryptographically secure hash which is a one way function will create output that has a uniform distribution and can be computed in polynomial time. The output should be in fact random, although can be affected by size of input. Given a sufficiently large input the output will be random (within limits). The size of input required is dependent on the strength of the hash functions employed. In essence output can be considered evenly distributed and random. In cryptographically secure hashing, the data is analysed and a fixed length key called the hash of the data is produced. The hash cannot reveal the original data.

A hash function can be thought of as a unique digital fingerprint. However, it is possible to have two pieces of data with the same hash result. This is referred to as a collision and reduces the security of the hash algorithm. The more secure the algorithm, then the likelihood of a collision is reduced.

Early hash algorithms such as MD4, MD5 and even early SHA are considered broken, in the sense that they simply allow too many collisions to occur. Hence larger descriptors (keylengths) and more efficient algorithms are almost always required.

The following is one approach for carrying out the encryption method of the invention.

The data is split into a number of data portions or chunks (Cₙ). A hash of each chunk is taken (H_{cn}). In the case of AES or a similar cipher, [keysize] (Cₙ₋₁) is used as the key, and [next bytes iv size](Cₙ₋₁) is used as the IV (for AES 0 to 32==key and 32 to 48==iv).

Next, an obfuscation chunk (OBFCₙ) is created by concatenating the hashes of other chunks ([unused part of ](Cₙ₋₁)(Cₙ₋₂)(Cₙ).

An encryption cipher or similar reversible method is then run on (Cₙ), to produce random data (C_{random}).

The data can now be considered to be randomised and of the same length as the input data. The obfuscation chunk (OBFCₙ) is also random output, but of a length less than the input data.

Next, the operation (OBFCₙ)(repeated) XOR (C_{random}) is taken to produce the output data. Each of the output data is renamed with the hash of the new content and these hashes and saved.

A One Time Pad as defined by Shannon is regarded as the only cryptosystem with theoretically perfect secrecy. It presupposes the following: pads cannot be reused; for a Shannon implementation (as opposed to earlier cyclic pads) the pad must be as long as the message to be encrypted (i.e. a pad must be non-repeating); and the pad must contain only random data.

As the Shannon system suggests, a one time random pad which is longer than the data to be encrypted is required for a true one time pad. In this specification, a symmetric encryption cypher (AES as example, with CFB) is used to introduce what can be described as randomness to the data itself. If this is truly random then it's the perfect pad in it's own right. Furthermore, an obfuscation pad is used, which almost creates a pad that is usable as a one time pad, however the pad is not as long as the message to be encrypted (it repeats as it is shorter than the data to be encrypted).

However, the data itself can be considered to be the pad and the obfuscation chunk is now repeating data (which is allowed by the definition of the Shannon Pad). Although this is a rather large amount of repeating data, it is also repeating random data. This can be considered as a form of one time pad. In addition, the actions taken on the data to include randomness as well as pad randomness result in increased security.

File Chunking

The size of the file (f.size( )) is taken and the number (n) of chunks calculated. The number of chunks depends on the desired implementation, for instance a maximum number of chunks or a maximum chunk size may be desired.

Chunks of 256 KB (settable) in length are created and then hashed. A hash of each chunk is taken, these are then hashed, and a structure is created which will be referred to as a data map.

The chunks are created with a fixed size to ensure that the set required to recreate the file is almost as large as the number of available chunks in any data store. This data map is mapped to the file metadata using fh.

Encryption Step

In the encryption stage, two separate non deterministic pieces of data are required: the encryption key (or password) and the Initialisation Vector (IV). To ensure all data encrypts to the same end result, the IV is determined from what can be considered non deterministic data, that being the hash of one of the chunks.

Data is encrypted with the Key and IV (Enc_{[key][IV]}(data)). It is assumed that the

Key and the IV for chunk n are derived from separate portions of the hash of chunk n−1. In the case of AES for instance, the first 32 bytes of this hash are the Key and the next 16 bytes are the IV (Enc[H(C_{n-1 [first 32 bytes]})][H(C_{n-1 [32 to 48 bytes]})][C_{Xn})=C_{Xen}).

Therefore, these items are selected from random data, although the randomness can be deterministic (if the output of an algorithm such as AES can be guessed, by guessing the input parameters, i.e. brute force) in the case of a one way function such as a cryptographic hash (as discussed).

The data is now represented as chunks of highly obfuscated chunks. The hash of each chunk is then taken again H(Cₓₑₙ) and each chunk is renamed with the hash of its content.

Obfuscation Step

In the obfuscation step, each chunk is polluted with data from other chunks. For Cₙ, an identically-sized data chunk is created by repeatedly rehashing the hash of chunk n+2 and appending the result (H(Cₙ₋₂)+H(H(Cₙ₊₂))+H(H(H(Cₙ₊₂)))+ . . . ). This is called the XOR chunk n (CXORn) and is XOR'ed with chunk n. Although

XOR has been used to obfuscate the data, this is not restrictive in any way and may be replaced by other obfuscation methods.

Data Map

Data maps are used to reverse the above process to retrieve the plain-text from the cipher-text chunks.

The encryption process can be reversed using data from the following steps that were described above: splitting the data into a number of chunks (Cₙ); [keysize] (Cₙ₋₁) as the key and [next bytes iv size](Cₙ₋₁) as the IV; and the obfuscation chunk (OBFCₙ). This data is stored in a structure referred to as a data map. This is described in the following table.

fh = H(H(C₁) + H(C₂) + . . . H(Cₙ₋₁)

| | |
|---|---|
| H(C₁) | H(Cₓₑ₁) |
| H(C₂) | H(Cₓₑ₂) |
| . . . | . . . |
| H(Cₙ) | H(Cₓₑₙ) |

In the above case, the hash of the concatenated pre-encryption hashes is used as the file hash. This is efficient in terms of processing time. However, the full file hash may be used.

With the above structure, the names of all the chunks are in the right hand column and all passwords and IV's (which are derived from the original chunk hashes) are stored in the left hand column. The file hash in the top row identifies the data element and acts as the unique key for this file.

Reversing the process is now straightforward. The chunks listed in right hand column are retrieved and each XOR chunk is created again. The obfuscation stage is reversed and each result decrypted. The results are concatenated.

This is the complete encrypt/decrypt process for each file.

The data maps (dm) from multiple files can be concatenated into a new structure referred to as the data atlas (da). Therefore, dm₁+dm₂+ . . . =da. This data atlas is itself now a large piece of data and is fed into the self-encryption process once more. This produces a single data map and more chunks. These chunks can be stored and the single remaining data map is the key to all the data.

The present invention allows for multiple data elements to be encrypted in a powerful fashion. All data is encrypted using no user information or input. This means that if the container for all the chunks is a single container then duplicate files will produce the exact same chunks and the storage system can automatically remove duplicate information. It is estimated the savings in data storage for such a system would be greater than 95%. Data compression could also be used during the hash/encryption of each chunk. This would further improve efficiency, particularly with regard to improving data de-duplication results.

Also, any break in an encryption cipher will not reveal any data to an attacker.

Whilst specific embodiments of the present invention have been described above, it will be appreciated that departures from the described embodiments may still fall within the scope of the present invention.

1. A method of encrypting data comprising the steps of:
creating a one time pad; and
encrypting the data using the one time pad to produce output data, wherein the one time pad is generated using the data.

2. The method as claimed in claim 1, further comprising splitting the data into a plurality of data portions.

3. The method as claimed in claim 2, further comprising taking a hash of each data portion.

4. The method as claimed in claim 1, further comprising obfuscating the data.

5. The method as claimed in claim 4, further comprising including obfuscating each data portion.

6. The method as claimed in claim 5, further comprising obfuscating each data portion_by concatenating the hashes of one or more other data portions.

7. The method as claimed in claim 4, including encrypting the obfuscated data using the one time pad.

8. The method as claimed in claim 2, wherein the one time pad comprises key data which is generated by encrypting the data.

9. The method as claimed in claim 8, wherein the encryption process used to generate the key data includes one or more encryption parameters derived from the data.

10. The method as claimed in claim 9, wherein the one or more encryption parameters are derived from one or more data portions.

11. The method as claimed in claim 9, wherein the one or more encryption parameters comprise at least one encryption key.

12. The method as claimed in claim 9, wherein the one or more encryption parameters comprise at least one initialisation vector.

13. The method as claimed in claim 8, wherein the key data is at least the same length as the data.

14. The method as claimed in claim 1, wherein the encrypted data is named using a hash of the encrypted data and then stored.

15. The method as claimed in claim 9, including generating a data map for decrypting the output data.

16. The method as claimed in claim 15, wherein the data map comprises the one or more encryption parameters.

17. The method as claimed in claim 1, including generating a data atlas from a plurality of data maps.

18. The method as claimed in claim 17, wherein the data atlas comprises a plurality of concatenated data maps.

19. The method as claimed in claim 1, including removing duplicate information.

20. The method as claimed in claim 19, including at least reducing the number of multiple versions of identical data portions.

21. A device for encrypting data comprising:
a processor configured to create a one time pad and to encrypt the data using the one time pad to produce output data, wherein the processor is configured to generate the one time pad using the data.
